(19) United States
(12) Patent Application Publication
(10) Pub. No.: US 2025/0379918 A1
(43) Pub. Date: Dec. 11, 2025

(54) HTTP REDIRECTION

(71) Applicant: BRITISH TELECOMMUNICATIONS PUBLIC LIMITED COMPANY, London, Greater London (GB)

(72) Inventors: Paul FARROW, London, Greater London (GB); Michael NILSSON, London, Greater London (GB); Stephen APPLEBY, London, Greater London (GB)

(21) Appl. No.: 18/878,593

(22) PCT Filed: May 26, 2023
(86) PCT No.: PCT/EP2023/064216

§ 371 Date: Dec. 23, 2024

(30) Foreign Application Priority Data
Jun. 30, 2022 (EP) 22182158.0

(51) Int. Cl. H04L 67/563; H04L 61/2517; H04L 67/02

(52) U.S. Cl. CPC H04L 67/563; H04L 61/2517; H04L 67/02

(57) ABSTRACT

Examples relate to a method of performing HTTP redirects. An intermediary node, such as a home gateway, receives an HTTP request from a client device for a resource located at a content server. The intermediary node, such as a gateway device. determines that the resource is one that could be provided instead by a different source from that of the content server. for example instead by a proxy that is be co-located with the intermediary node. The intermediary node then performs network address translation to modify the source port number associated with the HTTP request to one from a predetermined set of source port numbers, before forwarding the HTTP request with the modified source port number to the content server. The content server receives the request and determines that the source port of the HTTP request is one of the predetermined set of source port numbers. and thus sends an HTTP redirect message to the client device, wherein the HTTP redirect message is addressed to a domain associated with the proxy.

### FIELD OF THE INVENTION

This invention relates to the field of HTTP redirection.

### BACKGROUND TO THE INVENTION

HTTP redirection is used throughout the Internet to enable many services to operate, not only redirecting due to moved resources, but also to correctly route requests to the relevant resource based on numerous factors. The concept behind redirection is to indicate to a client that the requested resource should be found at a different location than the one the original request is directed to. The resource can then be requested by the client at the new location indicated by the redirection. For example, a request might be made for video content from a particular content server, but the content might not be available there anymore, so the content server can send a redirect message back to the client directing it to an alternative source where the requested content is available.

HTTP redirection methods can indicate either a temporary or permanent redirect to enable caching of the redirect response on the client for use with further requests. The redirection responses can also be cached for a designated amount of time on the clients, to reduce network traffic and speed up subsequent requests.

For normal service availability detection, an out of band mechanism is usually put in place to provide information on service discovery. This could involve a database containing service locations, as well as a mechanism of update for when service availability changes. However, this requires significant management and interoperability between the service provider and the system making the availability lookup. Additionally, the cost of such a system can often be prohibitive when scaled to a large size. Therefore, systems often look to build in band communication methods to determine service availability.

When clients request content from an online source using a URI (universal resource identifier) or other identifier, the request can pass through several domains of control before it is handled on the final destination device. This is usually an automated process which is based on rule lists held on intermediary devices, which are generally preconfigured and static in nature, matching the request on a number of factors such as source IP, domain, resource and load balance policy.

The process of redirection from the source device making the request and the final destination device becomes a chain of conditional operations, with each step consisting of either a redirection message being sent to the client, a server handled redirection, or the final handling of the request.

A redirection message sent to the client would usually be signalled with a HTTP 30x based response, whereby the client would then make a subsequent request based on the information in the redirection message, continuing the chain of redirection. A server handled redirection would pass the request directly onto the next device in the chain, thereby moving to the next step in the chain. Finally, the handling of a request on the final destination device would result in the expected response back to the source client device.

As mentioned, the process of intermediary devices in the redirection chain making decisions is usually based on simple logic, whereby a requester's IP address, and requested resource and domain are used to determine the correct action to take. This can involve identifying a complete match in a database or lookup table, or partial matching for the requested resource possibly using regular expressions; additionally, in the case of IP, a longest prefix match can also be used. The described static lookup is often satisfactory for the operation of many services, however, when more advanced services are in operation, improvements to this functionality can be beneficial.

US patent application US20050265252A1 relates to methods, systems, and media to sub-divide an ephemeral port range and allocate ports from the sub-divided ephemeral port ranges based upon, e.g., application loads, anticipated and/or actual load conditions, quality of service, performance guarantees, application starvation, process priority, user identifications, group identifications, process names, and/or the like.

### SUMMARY OF THE INVENTION

It is the aim of examples of the present invention to provide an improved HTTP redirection method.

According to one example of the invention, there is provided a method of managing HTTP requests, said method comprising:
receiving at a network module an HTTP request for a resource located at a first server, wherein the HTTP request is from a client device;
determining by the network module that the request should be redirected to a second server, and then modifying the source port number associated with the HTTP request to a number from a predetermined set of source port numbers;
forwarding by the network module the HTTP request with the modified source port number to the first server;
receiving by first server the forwarded HTTP request; and
determining (222) by the first server that the source port number of the HTTP request is a number from the predetermined set of source port numbers, and then sending an HTTP redirect message to the client device, wherein the HTTP redirect message is addressed to a domain associated with the second server.

The determining by the network module that request should be redirected may comprise checking the request satisfies predetermined criteria. The predetermined criteria may comprise a list of target IP addresses, and the target IP address of the request must match one of the target IP addresses from the list. The predetermined criteria may comprise a list of domains, and the domain of the request must match one of the domains on the list.

The first server may be a content server. The second server may be a proxy. The network module may be a gateway device.

The second server may be located with the network module.

According to a further example of the invention, there is provided a system for managing HTTP requests, said system comprising:
a network module adapted to receive an HTTP request for a resource located at a first server, wherein the HTTP request is from a client device, and to determine that the request should be redirected to a second server and then modify the source port number associated with the HTTP request to a number from a predetermined set of source port numbers, and said first module is further adapted to forward the HTTP request with the modified source port number to the first server; and
a first server adapted to receive the forwarded HTTP request, and to determine that the source port number of the HTTP request is a number from the predetermined set of source port numbers, and to send an HTTP redirect message to the client device, wherein the HTTP redirect message is addressed to a domain associated with the second server.

The redirection depends on the presence of an intermediary node, or a service that is available on the intermediary node, located between the client device making the request and the original destination of that request. This intermediary node could be a proxy that is located on a residential gateway device, the client device or some other intermediary device.

Advantageously, separate out-of-band signalling of the availability of the intermediary node is not required as TCP source port numbers associated with the request itself are used to signal a need to redirect in-band. Typically, adding out-of-band signalling increases complexity and requires identifying traffic and maintaining state, which can present scalability issues with large volumes of traffic. A separate system for managing the additional signalling would also be required. Identifying the traffic can also be an issue if encryption is used, making inspection of the request difficult.

The setting of the source port number utilises the Network Address Translation (NAT) functionality found in many network devices, such as home gateways, where the source port number can be set to a value within a predetermined set or range. This can be done conditionally on a particular gateway application or proxy being available at the gateway device for receiving redirected requests.

The setting of the source port number can also be applied on the client device instead of a gateway device or other intermediary device.

The described method provides in-band identification of the need to redirect without modification of the HTTP request itself.

### BRIEF DESCRIPTION OF THE DRAWINGS

For a better understanding of the present invention reference will now be made by way of example only to the accompanying drawings, in which:

FIG. 1 is a system diagram showing the main components of an example of the present invention;

FIG. 2 is a flow chart summarising the steps of an example of the invention; and

FIG. 3 is a flow chart summarising further steps of an example of the invention.

### DESCRIPTION OF PREFERRED EMBODIMENTS

The present invention is described herein with reference to particular examples. The invention is not, however, limited to such examples.

Examples of the present invention provide a method of performing HTTP redirects. An intermediary node, such as a home gateway, receives an HTTP request from a client device for a resource located at a content server. The intermediary node, such as a gateway device, determines that the resource is one that could be provided instead by a different source from that of the content server, for example instead by a proxy that is be co-located with the intermediary node. The intermediary node then performs network address translation to modify the source port number associated with the HTTP request to one from a predetermined set of source port numbers, before forwarding the HTTP request with the modified source port number to the content server. The content server receives the request and determines that the source port of the HTTP request is one of the predetermined set of source port numbers, and thus sends an HTTP redirect message to the client device, wherein the HTTP redirect message is addressed to a domain associated with the proxy. After receiving the redirect message, the client sends an updated HTTP request directed to the domain identified in the redirect message. Thus, HTTP redirection is initiated by an intermediary node when certain conditions are met, such as when a proxy can be used to provide a requested service, without the need of any further signalling or modification of the original HTTP request itself.

Examples of the invention will now be presented with reference to a content delivery system.

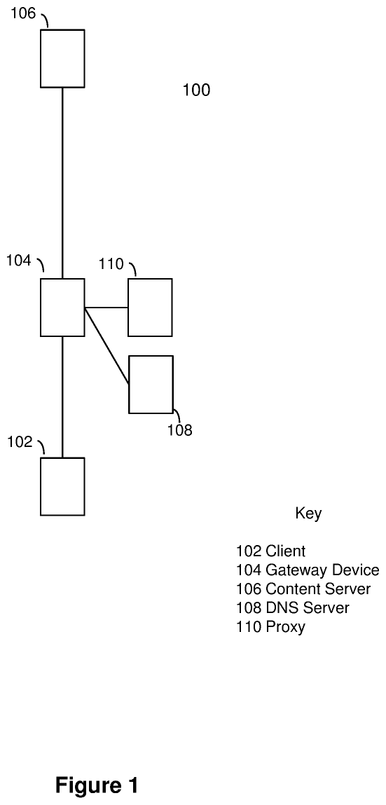

FIG. 1 shows an example content delivery system 100. The system 100 comprises a client device 102, a gateway device 104, a content server 106, a DNS server 108 and a proxy 110. The content server 106 provides responses to the client device 102 as a result of content requests received from the client device 102. In this example, the DNS server 108 and proxy 110 are located within the gateway device 104. For example, the DNS server 108 and proxy 110 may be implemented as software modules with the gateway device 104. However, the DNS server 108 and the proxy 110 can be located elsewhere, such as on the client device 104. The client device 102 may be for example a TV set-top box, a laptop, a tablet or smartphone.

The client device 102 makes a HTTP request for content using a given resource universal resource indicator (URI). In this content delivery example where the client device 102 is looking to make requests for video content using a protocol such as HTTP Live Streaming (HLS), the request could be for a video manifest or playlist file (such as a .m3u8 format playlist file), which lists specific video content segments and where they can be retrieved from. However, the request could be for some other resource such as software updates, audio files, or any other data. The domain name from the URI is then resolved to an IP address through normal DNS lookup procedures using the DNS server 108. This IP address is then used to send an HTTP request for the resource identified in the URI to the content server 106 located at the resolved IP address. In this example, the IP address is that of the content server 106, and the HTTP request is routed from the client 102 to the gateway device 104 using a default route assignment in a client routing table.

Whilst the request made by the client device 102 has been described as an HTTP request in the specific example, the method can equally be applied to a client device 102 making HTTPS requests.

The gateway device 104 then performs Network Address Translation (NAT) on the received request to allow the privately addressed IP packet to be routed over the public Internet. The TCP source port number in this example would usually be assigned a random number between 1024 and 49151. However, the gateway device 104 in examples of this invention sets the TCP source port number to within a smaller pre-determined set or range of source port numbers when a request compatible with a service provided by the proxy 110 is detected. In the case of this example, the service could be a video streaming service for content stored at the proxy 110 instead of at the content server 106. Examples of such a service are described in the Applicant's International applications WO2020/173878 and WO2020/173984, where a client device makes requests for content over unicast from a content server, but that content is provided over unicast by a proxy that has received the same content over multicast.

The detection of a request for a compatible service that can be serviced by the proxy 110 can be achieved in a number of ways, all of which effectively check that the request satisfies certain predetermined criteria. The first way is to examine the target IP address and see if it matches a predetermined target IP address, which could be pre-configured or updated by the proxy 110. Another way is to use the domain name used for the request, which could either be detected through Server Name Identification (SNI) or by capturing and recording the DNS lookup result performed by client 102, and checking to see if it matches a predetermined domain. Other criteria could also be used for specific content types, such as using the destination port to identify the type of traffic or service. In all cases, the aim is to detect certain criteria in the requests, and then process the requests them using examples of the invention as described. The criteria can be stored at the gateway device 104 in a list, and managed by the proxy 110.

The NAT processed IP packet will then be routed from the gateway device 104 over the Internet and received by the content server 106. The content server 106 then determines whether the HTTP request should be redirected to an alternative service, such as one provided by the proxy 110. This can be done by checking the source port number on the received IP packet, and determining if it falls within the pre-determined set of source port numbers. If so, the content server 106 responds with an HTTP redirection response message with the URI configured to enable the use of the proxy 110 to deliver the requested playlist file. Subsequent requests for content segments can then be served from the proxy 110. This is achieved using the relative addressing used for segment notation within the playlist file; whereby only the resource path of the segment is noted and is appended to the original domain used to obtain the playlist file. However, requests received at the content server 106 with source port numbers outside the set of predetermined source port numbers will either be served the requested resource from the content server 106 or redirected to another location where the resource is available.

There may be instances where a redirection occurs when the service at the proxy 110 is not actually active. This might happen if the gateway device 104 does not operate according to this invention, but still randomly sets the source port number to one that fall within the predetermined set of source port numbers. However, such requests would be a small number in comparison to the number of properly redirected requests.

An important point to highlight is the use of HTTPS for most services on the Internet, which by its very nature prevents the contents of the requests from being visible by intermediary devices. Therefore, the content of an HTTPS request made by the client 102 would not be visible to the gateway device 104, only specific header information, such as the SNI.

In an alternative approach, the gateway device 104 and the proxy 110 may instead reside as software modules on the client device 102.

This same general approach of source port number selection to one of a predetermined set can also be applied when the proxy 110 resides somewhere else in the network 100 other than the gateway device 104 or indeed the client device 102.

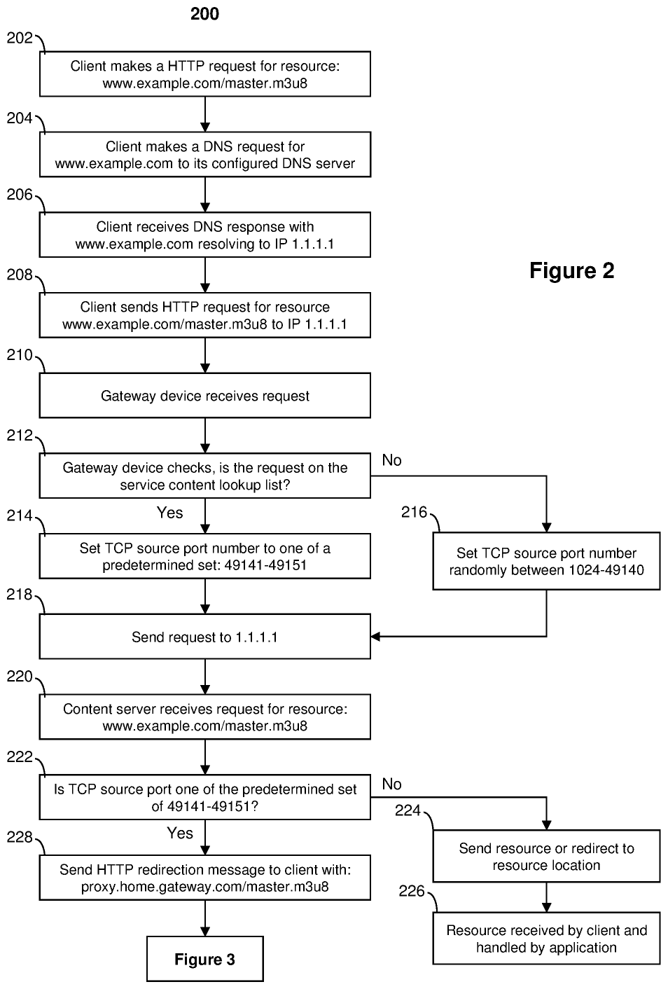

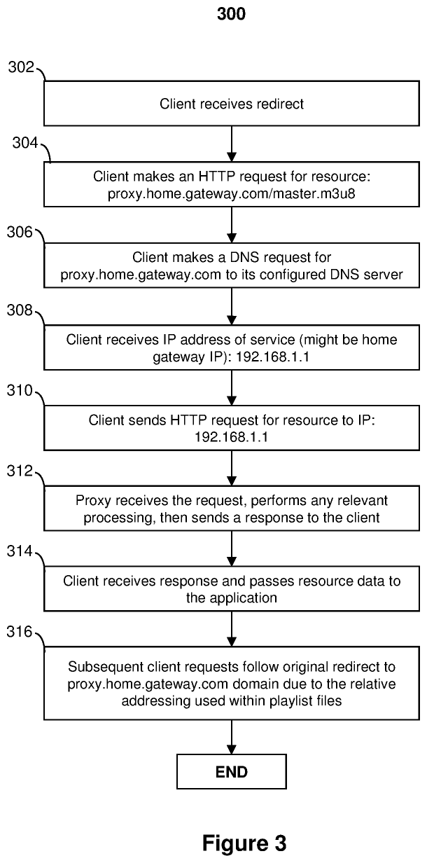

There now follows a more detailed worked example of the invention referencing the flow charts of FIG. 2 and FIG. 3.

FIG. 2 shows a flow chart 200, with processing starting at step 202.
In step 202, the client device 102 makes an HTTP request for a specific resource, which in this example is a manifest file with the URI: www.example.com/master.m3u8.
In step 204, the client device 102 determines the IP address to send the request to, based on the domain name. Therefore, the client device 102 sends a DNS request for www.example.com to the DNS server 108.
In step 206, the client device 102 receives the DNS response from the DNS server 108, with the IP address for the domain www.example.com, which in this example resolves to 1.1.1.1.
In step 208, using the IP address determined in step 206, the client device 102 sends the HTTP request (URI: www.example.com/master.m3u8) to the content server 106.
In step 210, the gateway device 104 receives the request due to the default IP route installed on the client device 102.
In step 212, the gateway device 104 checks to see if the HTTP request should trigger a redirect to a service on the proxy 110. This check can be performed using, for example, IP lookup or domain matching against a list stored at the gateway device 104. This is possible even when handling HTTPS requests due to the SNI being available unencrypted in the request header. For example, the list can be used to identify IP addresses (e.g. 1.1.1.1) or domains (e.g. www.example.com) of requests that should be redirected to a service at the proxy 110. Such a list can be managed by the proxy 110, which is able to update the list depending on what services are available at the proxy 110 at any given time.

If there is an alternative service available at the proxy 110, then processing passes to step 214 (which it does for the purpose of this example). In step 214, as part of the network address translation service (NAT) process, the gateway device 104 sets the TCP source port number to a number from a predetermined set of source port numbers. This can be done randomly. For example, the predetermined set of source port numbers could be from 49141-49151 (compared to the usual available range of 1024-49151). Processing then passes to step 218.

However, if there is no alternative service available from step 212, then processing passes to step 216. In step 216, as part of the NAT process, the gateway device 104 sets the TCP source port number to a random value between 1024-49140, which is the standard random allocation range used in NAT, except it excludes the predetermined set of source port numbers used by the gateway device 104 in step 214. Processing then passes to step 218.
In step 218, the gateway device 104 forwards the request to the content server 106 at IP address 1.1.1.1 after completing the modified NAT process of either steps 214 or 216.
In step 220, the HTTP request is received at the content server 106.
In step 222, the content server 106 checks to see if the TCP source port number of the request is one of the predetermined set of numbers of 49141-49151 to signify the availability of an alternative service on the proxy 110. If the source port number is not one of the predetermined set, the processing passes to step 224. If the source port number is one of the predetermined set, then processing passes to step 228.
In step 224, the source port is outside of the predetermined set, so the resource (playlist) requested is sent back to the client 102 from the content server 106 (or redirected according to normal operation).
In step 226, the client 102 receives the response from the content server 106 and handles it as normal.
In step 228, the source port number is found to be one of the predetermined set by the content server 106, so the content server 106 sends back an HTTP redirect message to the client 102 using a URI with a specific domain associated with the alternative service on the proxy 110. In this example, the redirect URI is: proxy.home.gateway.com/master.m3u8. Processing then moves onto the flow chart 300 of FIG. 3.

In the above example, a single set of source port numbers is used to redirect to a single domain on the proxy 110. However, different sets of source port numbers could be used to redirect to respective different instances of proxy 110. For example, one set of source port numbers could be used to redirect to a first service (such as a live football streaming service) on the first instance of proxy 110, and a second different range of source port numbers could be used to redirect to a second service (such as a live news streaming service) on the second instance of proxy 110.

FIG. 3 shows a flow chart 300 summarising the steps that follow once the client device 102 receives the redirect from the content server 106.
In step 302, the client device 102 receives the redirect from the content server 106.
In step 304, the client device 102, initiates an HTTP request to the redirected URI, which in this example is proxy.home.gateway.com/master.m3u8.
In step 306, the client device 102 initiates the process of finding the IP address to send the new request to, with the client device 102 sending a DNS request for the domain (proxy.home.gateway.com) to its configured DNS server 108.
In step 308, the DNS server 108 responds to the DNS request with the IP address of the proxy 110, which in this example is 192.168.1.1. The IP address is received by the client device 308.
In step 310, the client device 102 sends the HTTP request (URI: proxy.home.gateway.com/master.m3u8) to the resolved IP address from step 308 of 192.168.1.1.
In step 312, the proxy 110 receives the HTTP request, performs any necessary processing and then sends a response to the client 102. In this case, the response will be the requested playlist file master.m3u8.
In step 314, the client device 102 receives the response from the proxy 110, passing the resource data to the relevant application module.

Finally, in step 316, since the initial request was for a master.m3u8 playlist file, subsequent requests for related content segments referenced within the playlist file will be automatically directed to the proxy.home.gateway.com domain without a redirect being required from the content server 106. This is due to the relative addressing scheme used within playlist files.

In general, it is noted herein that while the above describes examples of the invention, there are several variations and modifications which may be made to the described examples without departing from the scope of the present invention as defined in the appended claims. One skilled in the art will recognise modifications to the described examples.

1. A method of managing HTTP requests, said method comprising:
receiving (210) at a network module an HTTP request for a resource located at a first server, wherein the HTTP request is from a client device;
determining (212, 214) by the network module that the request should be redirected to a second server, and then modifying the source port number associated with the HTTP request to a number from a predetermined set of source port numbers;
forwarding (218) by the network module the HTTP request with the modified source port number to the first server;
receiving (220) by first server the forwarded HTTP request;
determining (222) by the first server that the source port number of the HTTP request is a number from the predetermined set of source port numbers, and then sending (228) an HTTP redirect message to the client device, wherein the HTTP redirect message is addressed to a domain associated with the second server.

2. A method according to claim 1, wherein the determining by the network module that request should be redirected comprises checking the request satisfies predetermined criteria.

3. A method according to claim 2, wherein the predetermined criteria comprises a list of target IP addresses, and the target IP address of the request must match one of the target IP addresses from the list.

4. A method according to claim 2, wherein the predetermined criteria comprises a list of domains, and the domain of the request must match one of the domains on the list.

5. A method according to claim 1, wherein the first server is a content server.

6. A method according to claim 1, wherein the second server is a proxy.

7. A method according to claim 1, wherein the network module is a gateway device.

8. A method according to claim, wherein the second server is located with the network module.

9. A system for managing HTTP requests, said system comprising:
a network module adapted to receive an HTTP request for a resource located at a first server, wherein the HTTP request is from a client device, and to determine that the request should be redirected to a second server and then modify the source port number associated with the HTTP request to a number from a predetermined set of source port numbers, and said first module is further adapted to forward the HTTP request with the modified source port number to the first server; and
a first server adapted to receive the forwarded HTTP request, and to determine that the source port number of the HTTP request is a number from the predetermined set of source port numbers, and to send an HTTP redirect message to the client device, wherein the HTTP redirect message is addressed to a domain associated with the second server.
